(19) United States
(12) Patent Application Publication
(10) Pub. No.: US 2017/0276203 A1
(43) Pub. Date: Sep. 28, 2017

(54) SUPPLEMENTARY SPRING

(71) Applicant: BASF SE, Ludwigshafen (DE)

(72) Inventor: Mario WOLFF, Ostercappeln (DE)

(73) Assignee: BASF SE, Ludwigshafen (DE)

(21) Appl. No.: 15/422,047

(22) Filed: Feb. 1, 2017

Related U.S. Application Data
(63) Continuation of application No. 13/058,229, filed on Feb. 9, 2011, now abandoned.

(30) Foreign Application Priority Data
Aug. 20, 2008 (EP) 08162670.7

(51) Int. Cl. F16F 1/373; F16F 1/376; F16F 9/58

(52) U.S. Cl. CPC F16F 1/3732; F16F 9/58; F16F 1/376

(57) ABSTRACT

The invention relates to a hollow spring element of which the outer surface has at least one peripheral notch, which has at its base a notch geometry with a radius of curvature of less than 1 mm.

The invention relates to hollow, rotationally symmetrical flexible spring elements (i) and hollow, rotationally non-symmetrical flexible spring elements (i), e.g. with an oval base area and a shaped body with elevations on the lateral surface, preferably to hollow, rotationally symmetrical flexible spring elements (i), the outer surface, i.e. the lateral surface, of the spring element having at least one, preferably 1 to 6, particularly preferably 1 to 4, in particular 1 to 3, circumferential notch(es) (xii), which have on its/their base a notch geometry with a radius of curvature (xiv) of less than 1 mm, preferably less than 0.3 mm, particularly preferably between 0.1 mm and 0.25 mm. “Circumferential” means that the notches reduce the diameter of the spring element over the entire circumference of the spring element. The invention also relates to automobile chassis comprising the spring elements according to the invention, in particular automobile chassis in which the spring element according to the invention is positioned on the piston rod of the shock absorber, i.e. the piston rod is positioned in the continuous axially aligned hollow space of the spring element (i). Furthermore, the invention relates to automobiles, for example passenger cars, trucks or buses, comprising the spring elements according to the invention.

Suspension elements produced from polyurethane elastomers are used in automobiles, for example within the chassis, and are generally known, for example from DE 10 2004 049 638 A1, WO 2005/019681 and DE 203 11 242 U1. They are used in particular in motor vehicles as vibration-damping spring elements. In this case, the spring elements assume an end-stop function, influencing the force-displacement characteristics of the wheel by forming or reinforcing a progressive characteristic of the vehicle suspension. The pitching effects of the vehicle can be reduced and the prevention of rolling is enhanced. In particular as a result of the geometrical design, the initial rigidity is optimized, which has a decisive influence on the suspension comfort of the vehicle. The specifically selected design of the geometry produces component properties that are virtually constant throughout their service lives. This function increases the traveling comfort and ensures a high level of safety on the road.

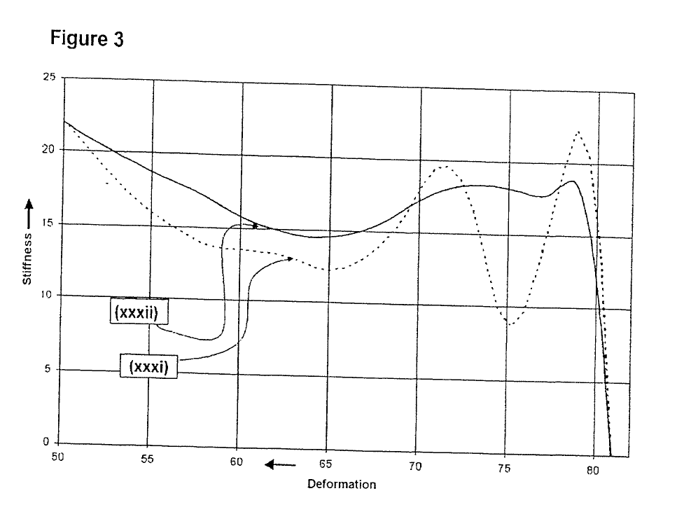

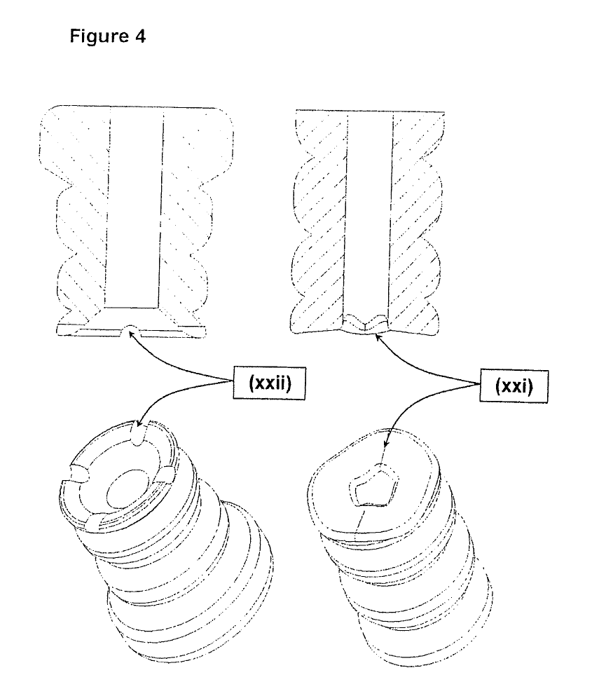

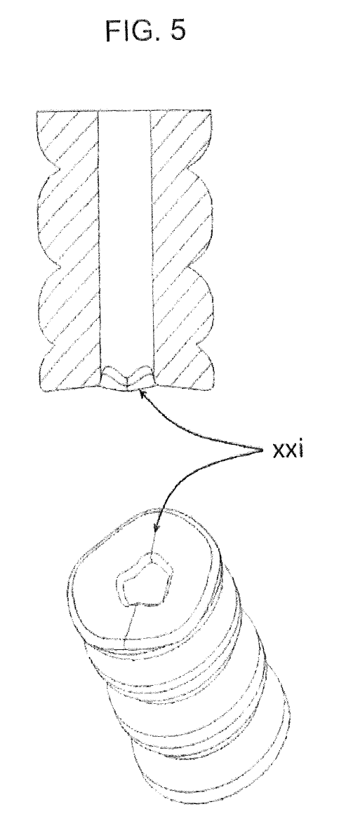

One difficulty in the three-dimensional configuration of these supplementary springs is that of achieving a characteristic that is as unobtrusive as possible when the resilient components engage in the spring elements, since every change in cross section on the spring element leads to sudden changes in stiffness in the spring characteristic (see FIG. 3, (xxxi)). At the same time, the contour is intended to withstand high cyclical loads and at the same time not allow material to swell beyond the installation space available.

It was consequently an object of the present invention to develop for a supplementary spring, preferably for a supplementary spring for an automobile chassis, a three-dimensional form which has a uniform, i.e. non-oscillating, stiffness profile (see FIG. 3, (xxxii)) and loads the material very homogeneously. It is essential for this that the spring element does not tend to bend, buckle or swell.

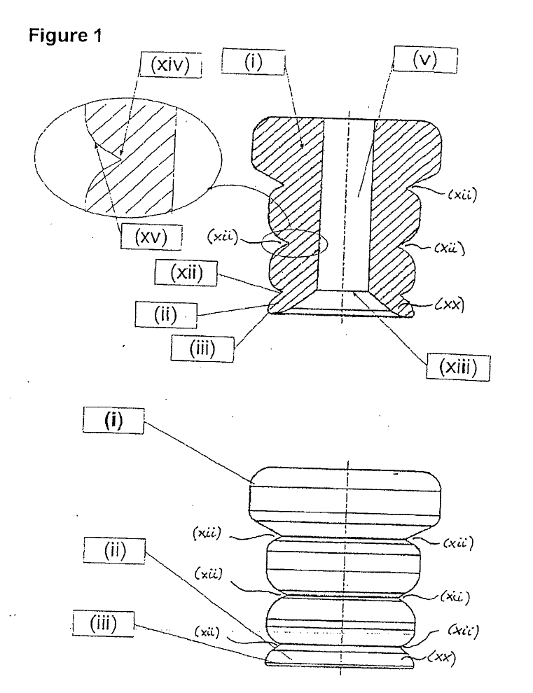

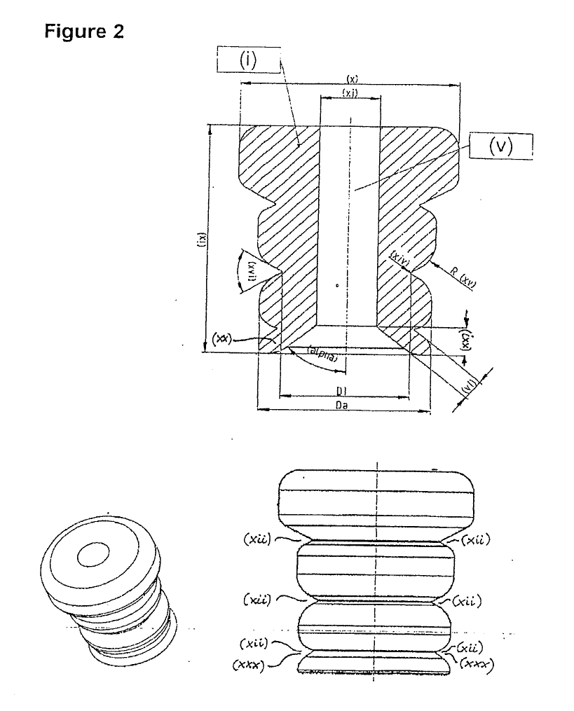

These requirements are met by the spring elements described at the beginning. A spring element according to the invention is represented by way of example in detail in FIGS. 1 and 2. In all the figures, the dimensions specified are given in [mm].

As can be seen from FIG. 3, in which the stiffness is plotted against the deformation of the spring, the configuration according to the invention, the profile of which is identified by (xxxii), shows a much more uniform stiffness profile than the comparative spring, the stiffness profile of which is identified by (xxxi).

The spring elements (i) according to the invention are distinguished by very narrow notches. In this case, the notches are preferably arranged coaxially. The notches represent constrictions which reduce the outer diameter of the spring element (i) over the entire circumference of the spring element.

The very narrow configuration of the notches in comparison with the prior art can achieve the effect that the notch folds immediately and in a defined manner at the notch base, while in the case of larger radii there is a sudden collapse with a corresponding drop in stiffness.

The large radii (xv) lead to a uniform increase in the size of the effective compressive cross section after the closing of the notch.

It was surprising for a person skilled in the art that this technical success could be achieved by the configuration of the notches according to the invention, since it is usually assumed that sharp-edged design features represent points at which spring elements (i) have a predisposition to tear under loading and strong deformation, and consequently represent weak points. It was also assumed that such a contour is accompanied by production problems in the form of pockets of trapped air, since the rising foam tends to fold over at the sharp-edged transition, and thereby trap air.

Spring elements (i) in which the circumferential constrictions on the outer surface are all configured in the form of the notch (xii) according to the invention are preferred.

The notch angle (xvi) of the notch (xii) is preferably less than 90°, particularly preferably less than 70°. In particular, the notch angle (xvi) of the notch (xii) is between 50° and 70°.

The notch angle of the notch is preferably arranged symmetrically about the horizontal plane in relation to the cylinder axis which passes through the lowest point of the constriction. The horizontal plane is defined by extending orthogonally in relation to the axis of rotation.

It is preferred furthermore that the radius of curvature of the notch periphery (xv) of the notch is greater than 3 mm, particularly preferably greater than 7 mm, in particular between 9 mm and 11 mm. Particularly preferably, the radius of curvature of the notch periphery (xv) has a radius which corresponds to the difference Da−Di, where Di is the diameter of the spring element (ii) at the base of the notch (xii) lying closest to the notch periphery and Da is the diameter of the spring element at the point at which the rounding runs in tangentially. This is represented in FIG. 2.

The spring element (i) preferably has a bending lip (xx), the bending lip (xx) being arranged at one axial end of the spring element. Generally known forms that ensure smooth compression come into consideration as bending lips, for example petal forms (a spring with a petal form is described for example in DE 20 2004 003 829 U1), undulating forms (WO 2005/019681) or an outwardly directed periphery (DE 10 2004 049 638 A1). Preferred among these are spring elements (i) in which the periphery (ii) of the bending lip (xx) is outwardly directed and the hollow space (v) of the spring element (i) widens at the height of the bending lip (xx). In this case, “height of the bending lip” means the part of the spring element in the axial direction in the region of which the bending lip (xx) is located. This height is in FIG. 1 the axial length, beginning at the point (xiii) and extending to the lower end of the spring element. This region may also be referred to as the run-out zone. According to FIGS. 1 and 2, the periphery (ii) is virtually the bending lip (xx), the bending lip (xx) representing the entire region at the end of the spring element (i) in which the hollow space (v) widens. In applications in which purely uniaxial loading predominates to a great extent and the use of an outwardly directed bending lip is provided, the occurrence of an initial sudden change in stiffness can be precluded by the contouring of the bending lip. This is preferably achieved by an undulating structure (xxi) or by interruptions (xxii). The reduction in the surface area that is taken up on first contact allows the force or stiffness profile to be significantly influenced. In the case of supplementary springs which undergo contact that is not purely axial, the non-contoured bending lip with an outwardly directed periphery should be preferred, since as a result only a small region comes into early engagement.

The particular, preferred configuration of the periphery (ii) is clear from the figures. This periphery preferably faces outward, i.e. away from the hollow space of the spring element. This means that the hollow space opens to the end face of the spring element as a result of the particular configuration of the periphery (ii). The term “end face” should be understood here as meaning not the lateral surface of the cylinder, but at least one, preferably both end areas, which are preferably located perpendicular to the lateral surface at the two axial ends of the cylinder. “Axial direction” should be understood as meaning the direction parallel to the height of the cylinder. This configuration achieves the effect on the one hand that the initial response of the spring is smooth. On the other hand, the configuration according to the invention opens up production advantages, since the spring element can be demolded more easily, more quickly and with less scrap. The preferred periphery (ii) is clearly identified in FIGS. 1 and 2. It represents the axial end of the spring element (i), the termination of which is formed by the edge (iii).

This preferred configuration of the bending lip together with the narrow notches according to the invention, running around the entire circumference of the spring element (i), ensures that the increase in stiffness proceeds uniformly up to the loading limit, i.e. does not oscillate. Also achieved is the tendency for the material under axial deformation to push in the direction of the hollow space (v), in which the piston rod of the shock absorber is usually located, which significantly reduces the swelling under strong loading. A phenomenon that occurs under certain geometrical conditions in the case of a conventional configuration is that the bending lip slips over over the contact body, which is generally represented by the shock absorber. This inevitably leads to a reduction in the long-term strength of the supplementary spring along with various further disadvantageous effects. The configuration described here fundamentally avoids this effect.

Particularly preferred are spring elements in which a notch (xii) is arranged in the portion of the spring element (i) in which the hollow space (v) widens, i.e. in the region of the bending lip (xx). This notch (xii), which is located in the region of the bending lip, is identified in FIG. 2 by (xxx), in addition to (xii). This offers the advantage that there is not a sudden increase in the effective cross-section, since the increase in cross-section at the bending lip has not been completed while the notch closes in the region of the bending lip (xxx). This effect is increased if the notch (xxx) is located between the transition (xiii) of the hollow space (v) to the bending lip (xx) and the end face of the spring element (iii).

Preferred are spring elements in which the angle a between the periphery (ii) preferably the surface of the periphery directed toward the hollow space, particularly preferably both the surface of the periphery (ii) directed toward the hollow space (v) and the outer lateral surface of the periphery (ii), and the longitudinal axis of the hollow space (v) is between 25° and 70°, particularly preferably between 35° and 60°, in particular 50°.

The periphery (ii) preferably has a thickness (vi) of between 2 mm and 8 mm, particularly preferably between 2 mm and 6 mm, in particular between 3 mm and 4 mm. The periphery (ii) preferably has a height (ixx) of between 5 mm and 20 mm, particularly preferably between 5 mm and 10 mm.

For supplementary springs, the spring element may take the generally customary dimensions, i.e. lengths and diameters. The spring element (i) preferably has a height (ix) of between 30 mm and 200 mm, particularly preferably between 40 mm and 120 mm. The outer diameter (x) of the spring element (i) is preferably between 30 mm and 100 mm, particularly preferably between 40 mm and 70 mm. The diameter (xi) of the hollow space of the spring element (i) is preferably between 10 mm and 30 mm. The expression hollow space should preferably be understood as meaning a hollow space that is continuous in the axial direction, i.e. extends through the entire spring element. The wall of the spring element (i), which bounds the hollow space, is preferably positioned coaxially in the preferably rotationally symmetrical spring element (i).

The spring elements (i) according to the invention are preferably based on generally known elastomers, for example rubber or polyisocyanate polyaddition products. They are preferably based on cellular polyurethane elastomers, which may optionally comprise polyurea structures, particularly preferably on the basis of cellular polyurethane elastomers which preferably have a density in accordance with DIN EN ISO 845 of between 200 and 1100 kg/m³, preferably 300 and 800 kg/m³, a tensile strength in accordance with DIN EN ISO 1798 of >2 N/mm², preferably >4 N/mm², particularly preferably between 2 and 8 N/mm², an elongation in accordance with DIN EN ISO 1798 of ≧200%, preferably ≧230%, particularly preferably between 300 and 700%, and a tear propagation resistance in accordance with DIN ISO 34-1B(b) of ≧6 N/mm, preferably ≧10 N/mm. The elastomers are preferably microcellular elastomers on the basis of polyisocyanate polyaddition products, preferably having cells with a diameter of 0.01 mm to 0.5 mm, particularly preferably 0.01 to 0.15 mm. Elastomers on the basis of polyisocyanate polyaddition products and their preparation are generally known and have been widely described, for example in EP-A 62 835, EP-A 36 994, EP-A 250 969, DE-A 195 48 770 and DE-A 195 48 771.

The preparation usually takes place by reacting isocyanates with compounds that are reactive to isocyanates.

The elastomers on the basis of cellular polyisocyanate polyaddition products are usually prepared in a mold in which the reactive starting components are reacted with one another. Suitable molds here are generally customary molds, for example metal molds, which, on account of their form, ensure the three-dimensional form of the spring element according to the invention.

The preparation of the polyisocyanate polyaddition products may take place on the basis of generally known methods, for example by using the following starting materials in a one-stage or two-stage process:
(a) isocyanate,
(b) compounds reactive to isocyanates,
(c) water and optionally
(d) catalysts,
(e) blowing agents and/or
(f) auxiliaries and/or additives, for example polysiloxanes and/or fatty acid sulfonates.

The surface temperature of the inner wall of the mold is usually 40 to 95° C., preferably 50 to 90° C.

The production of the molded parts is advantageously carried out using an NCO/OH ratio of from 0.85 to 1.20, the heated starting components being mixed and introduced into a heated, preferably tightly closing, mold in an amount corresponding to the desired density of the molded part.

The molded parts are cured, and can consequently be removed from the mold, after up to 60 minutes.

The amount of reaction mixture introduced into the mold is usually set such that the moldings obtained have the density already described.

The starting components are usually introduced into the mold at a temperature of from 15 to 120° C., preferably from 30 to 110° C. The degrees of compaction for the production of the moldings lie between 1.1 and 8, preferably between 2 and 6.

The cellular polyisocyanate polyaddition products are expediently prepared by the one-shot process with the aid of the low-pressure technique or in particular the reaction injection-molding technique (RIM) in open or preferably closed molds. The reaction is carried out in particular with compaction in a closed mold. The reaction injection-molding technique is described, for example, by H. Piechota and H. Röhr in “Integralschaumstoffe” [integral foams], Carl Hanser-Verlag, Munich, Vienna, 1975; D. J. Prepelka and J. L. Wharton in Journal of Cellular Plastics, March/April 1975, pages 87 to 98, and U. Knipp in Journal of Cellular Plastics, March/April 1973, pages 76-84.

1. A hollow spring element comprising an outer Surface.
wherein the outer surface of the spring element comprises at least one peripheral notch having a first side wall and a second side wall and a base, which has through the base a notch geometry with a continuous radius of curvature of less than 1 mm connecting the first and second side walls,
wherein a notch angle of the at least one peripheral notch is less than 90°.
a radius of curvature of a notch periphery of the at least one peripheral notch is greater than 3 mm, and
the spring element comprises a cellular polyurethane elastomer.

2. The spring element according to claim 1, wherein the notch angle of the at least one peripheral notch is arranged symmetrically about a horizontal plane in relation to a cylinder axis.

3. The spring element according to claim 1, further comprising:
a bending lip,
wherein the bending lip is arranged at one axial end of the spring element.

4. The spring element according to claim 3, wherein a periphery of the bending lip is outwardly directed and a hollow space of the spring element widens at the height of the bending lip.

5. The spring element according to claim 4, wherein an end face of the bending lip has an undulating structure or at least one interruption.

6. The spring element according to claim 1, wherein the at least one notch is arranged in the portion of the spring element in which a hollow space widens.

7. The spring element according to claim 1, wherein an angle between a periphery and a longitudinal axis of a hollow space is between 25° and 70°.

8. The spring element according to claim 1, wherein the notch periphery of the notch has a thickness of between 2 mm and 8 mm.

9. The spring element according to claim 1, wherein the notch periphery of the notch has a height of between 5 mm and 20 mm.

10. The spring element according to claim 1, having a height of between 30 mm and 200 mm.

11. The spring element according to claim 1, wherein an outer diameter of the spring element is between 30 mm and 100 mm.

12. The spring element according to claim 1, wherein a diameter of a hollow space of the spring element is between 10 mm and 30 mm.

13-15. (canceled)

16. The spring element of claim 1, wherein the cellular polyurethane elastomer is a microcellular elastomer.

17. The spring element of claim 1, wherein the cellular polyurethane elastomer comprises cells with a diameter of from 0.01 mm to 0.5 mm.

18. The spring element of claim 1,
wherein a three-dimensional form of the cellular polyurethane elastomer is obtained from a mold, and
the three-dimensional form of the cellular polyurethane elastomer comprises the notch geometry at the base of the at least one peripheral notch, the notch angle of the at least one peripheral notch, and the notch periphery of the at least one peripheral notch.

19. The spring element of claim 18, wherein the cellular polyurethane elastomer comprises cells with a diameter of from 0.01 mm to 0.5 mm.

20. The spring element of claim 1, configured to fold at the at least one peripheral notch, upon compression of the spring.

21. The spring element of claim 18, configured to fold at the at least one peripheral notch, upon compression of the spring.
